(19) United States
(12) Patent Application Publication
(10) Pub. No.: US 2023/0282231 A1
(43) Pub. Date: Sep. 7, 2023

(54) MAGNETIC DISK DEVICE AND METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Hidekazu MASUYAMA, Kawasaki Kanagawa (JP); Osamu YOSHIDA, Kawasaki Kanagawa (JP)

(21) Appl. No.: 17/903,896

(22) Filed: Sep. 6, 2022

(30) Foreign Application Priority Data
Mar. 7, 2022 (JP) 2022-034296

(51) Int. Cl. G11B 5/55; G06F 3/06; G11B 20/18; G11B 5/49

(52) U.S. Cl. CPC G11B 5/553; G06F 3/0676; G11B 20/18; G11B 5/4969; G11B 2220/2516

(57) ABSTRACT

According to one embodiment, first setting information and second setting information are stored in a memory included in a magnetic disk device. The first setting information indicates a second track that is a first track set to be disused on the basis of a defect inspection among a plurality of first tracks included in a magnetic disk. The second setting information indicates a third track selected from one or more first tracks different from the second track. In a case where an access destination is a user area, the controller converts logical address information into physical address information while slipping the second track and the third track. In a case where an access destination is a system area, the controller converts logical address information into physical address information while slipping all of the first tracks other than the third track among the plurality of first tracks.

### CROSS-REFERENCE TO RELATED APPLICATIONS

This application is based upon and claims the benefit of priority from Japanese Patent Application No. 2022-034296, filed on Mar. 7, 2022; the entire contents of which are incorporated herein by reference.

### FIELD

Embodiments described herein relate generally to a magnetic disk device and a method.

### BACKGROUND

In a conventional magnetic disk device, a predetermined number of tracks on an outer peripheral side of a magnetic disk may be set as a system area.

### BRIEF DESCRIPTION OF THE DRAWINGS

FIG. 1 is a view illustrating an example of a configuration of a magnetic disk device of an embodiment;

FIG. 2 is a schematic diagram for describing a logical address space included in the magnetic disk device of the embodiment;

FIG. 3 is a view illustrating an example of a configuration of each magnetic disk of the embodiment;

FIG. 4 is a view for describing various areas set on each recording surface of the magnetic disks of the embodiment;

FIG. 5 is a view illustrating an example of a data structure of track slipping area information of the embodiment;

FIG. 6 is a view illustrating an example of a track format of the magnetic disk device of the embodiment;

FIG. 7 is a view for describing a usage of the track slipping area information of the embodiment in a case where an access destination is a user area;

FIG. 8 is a view for describing a usage of the track slipping area information of the embodiment in a case where the access destination is a system area;

FIG. 9 is a view illustrating an example of an operation of setting the track slipping area information by the magnetic disk device of the embodiment;

FIG. 10 is a flowchart illustrating an example of an operation, which corresponds to an access command from a host, of the magnetic disk device of the embodiment;

FIG. 11 is a flowchart illustrating an example of an operation of accessing the system area by the magnetic disk device of the embodiment;

FIG. 12 is a flowchart illustrating an example of an operation of converting an LBA into CHS by the magnetic disk device of the embodiment; and

FIG. 13 is a flowchart illustrating an example of a reassigning operation executed by the magnetic disk device of the embodiment.

### DETAILED DESCRIPTION

In general, according to one embodiment, a magnetic disk device includes a magnetic disk, a magnetic head, a memory, and a controller. The magnetic disk has a plurality of first tracks. The memory stores first setting information and second setting information. The first setting information indicates a second track that is a first track, which is set to be disused on the basis of a defect inspection, among the plurality of first tracks. The second setting information indicates a third track, which is selected from one or more first tracks different from the second track, among the plurality of first tracks. In a case where an access destination is a user area, the controller converts first address information indicating the access destination in a logical address space into second address information indicating a position on the magnetic disk while slipping the second track and the third track on the basis of the first setting information and the second setting information, and accesses the magnetic disk by moving the magnetic head to the position indicated by the second address information. In a case where the access destination is a system area, the controller converts third address information indicating the access destination in the logical address space into fourth address information indicating a position on the magnetic disk while slipping all of the first tracks other than the third track among the plurality of first tracks on the basis of the second setting information, and accesses the magnetic disk by moving the magnetic head to the position indicated by the fourth address information.

In the following, a magnetic disk device and method according to an exemplary embodiment will be described in detail with reference to the accompanying drawings. Note that the present invention is not limited to the following embodiment.

### Embodiment

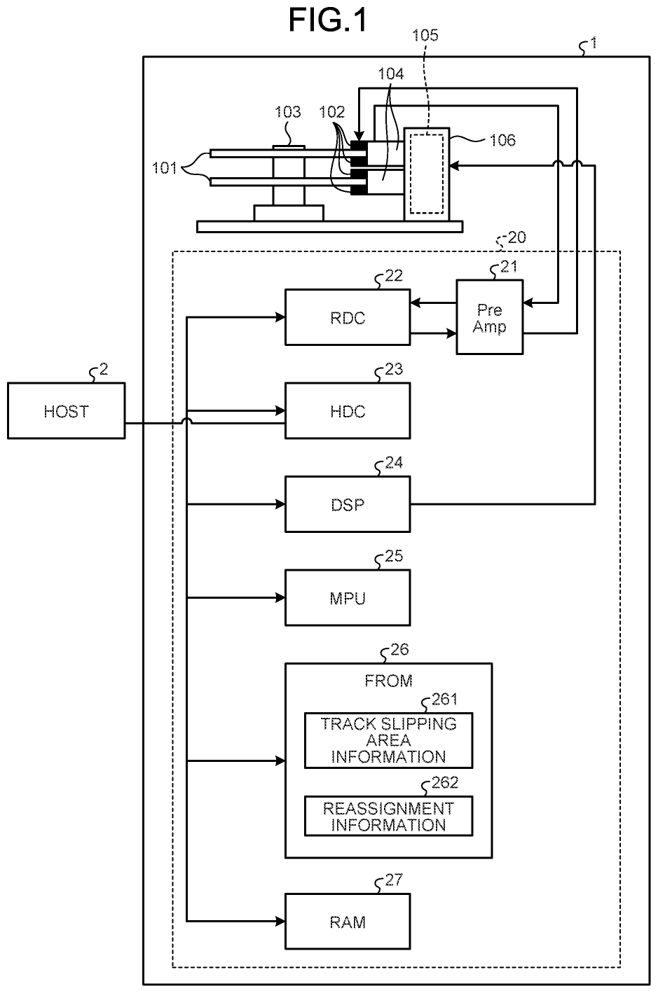

FIG. 1 is a view illustrating an example of a configuration of a magnetic disk device 1 of the embodiment. The magnetic disk device 1 can be connected to a host 2. A standard of a communication channel between the magnetic disk device 1 and the host 2 is not limited to a specific standard. In one example, a serial attached SCSI (SAS) is employed as a standard of the communication channel between the magnetic disk device 1 and the host 2.

The host 2 corresponds to, for example, a processor, a personal computer, a server, or the like. The magnetic disk device 1 can receive access commands from the host 2. The access commands include a read command and a write command.

The magnetic disk device 1 includes one or more magnetic disks 101. Here, as an example, the magnetic disk device 1 includes two magnetic disks 101. The two magnetic disks 101 are integrally rotated about a rotation shaft 103 by a spindle motor (not illustrated).

On a front surface and a back surface of each of the magnetic disks 101, recording surfaces on which data can be recorded are formed. That is, the two magnetic disks 101 have four recording surfaces. In order to access each of the four recording surfaces, the magnetic disk device 1 includes four magnetic heads 102 respectively corresponding to the four recording surfaces.

The magnetic disk device 1 includes two actuator arms 104. One of the two actuator arms 104 supports two of the magnetic heads 102 in such a manner as to respectively face the front surface and the back surface of one of the two magnetic disks 101. The other one of the two actuator arms 104 supports the remaining two magnetic heads 102 in such a manner as to respectively face the front surface and the back surface of the other one of the two magnetic disks 101.

Each of the magnetic heads 102 executes access, that is, writing of data and reading of data on a recording surface that faces the magnetic head 102 itself. Each of the magnetic heads 102 writes data by using a write element provided therein. Each of the magnetic heads 102 reads data by using a read element provided therein.

A rotation shaft 106 is provided at a position separated from the rotation shaft 103. The two actuator arms 104 are rotated within a predetermined range about the rotation shaft 106 by a voice coil motor 105. As a result, the four magnetic heads 102 are relatively moved in a radial direction with respect to the recording surfaces, respectively.

Note that the magnetic disk device 1 may include a plurality of voice coil motors 105 and a plurality of actuator arms 104, and the plurality of actuator arms 104 may be configured to be individually controllable by the plurality of voice coil motors 105, respectively.

The magnetic disk device 1 further includes a controller 20. The controller 20 communicates with the host 2 via an interface such as a connection pin that is provided, for external connection, in a housing (not illustrated) of the magnetic disk device 1. The controller 20 controls each unit of the magnetic disk device 1 in accordance with a command or the like from the host 2. As described above, the command from the host 2 includes the write command for requesting writing, and the read command for requesting reading.

The controller 20 includes a preamp 21, a read write channel (RDC) 22, a hard disk controller (HDC) 23, a digital signal processor (DSP) 24, a micro processing unit (MPU) 25, a flash read only memory (FROM) 26, and a RAM 27. The FROM 26 and the RAM 27 are examples of memories of the embodiment.

The preamp 21 amplifies a signal read by the read element of each of the magnetic heads 102 from a corresponding recording surface, and supplies the amplified signal to the RDC 22. Furthermore, the preamp 21 amplifies a signal supplied from the RDC 22, and supplies the amplified signal to the magnetic head 102 facing a recording surface of a writing destination.

The RDC 22 encodes data to be written, and supplies the encoded data to be written to the preamp 21. In addition, the RDC 22 decodes the signal read from the recording surface and supplied from the preamp 21. The RDC 22 outputs the decoded signal to the HDC 23 as digital data.

By controlling the spindle motor and the voice coil motor 105, the DSP 24 performs positioning control, such as seek and following, of each of the magnetic heads 102.

The RAM 27 has an area used as a work memory by the MPU 25. For example, a firmware program, management information, and the like are loaded into the RAM 27, and the MPU 25 executes control of the magnetic disk device 1 on the basis of these pieces of information loaded into the RAM 27.

The RAM 27 may also function as a buffer memory in which data or the like transferred between the host 2 and each of the magnetic disks 101 is temporarily stored. For example, data received from the host 2 is written into any of the magnetic disks 101 via the RAM 27. In addition, data read from the two magnetic disks 101 is output to the host 2 via the RAM 27.

The RAM 27 may include, for example, a dynamic random access memory (DRAM), a static random access memory (SRAM), or a combination thereof. Note that a kind of a memory included in the RAM 27 is not limited to the above.

The HDC 23 executes communication with the host 2. The HDC 23 stores the data received from the RDC 22 into the RAM 27. Then, the HDC 23 transfers, to the host 2, the data that is from the RDC 22 and that is stored in the RAM 27.

In addition, the HDC 23 stores, into the RAM 27, the data received together with the write command from the host 2. Then, the HDC 23 outputs, to the RDC 22, the data that is from the host 2 and that is stored in the RAM 27.

The FROM 26 is a nonvolatile memory that stores the firmware program and the management information.

In the embodiment, the track slipping area information 261 and reassignment information 262 are stored in the FROM 26 as the management information. Details of these pieces of information will be described later.

The MPU 25 is a processor that executes the firmware program. The MPU 25 loads the firmware program and the management information from the FROM 26 into the RAM 27 at the time of activation of the magnetic disk device 1. Then, the MPU 25 executes the control of the magnetic disk device 1 on the basis of these pieces of information loaded into the RAM 27. At the time of shutdown of the magnetic disk device 1, the management information used on the RAM 27 is non-volatilized by saving of the management information in the RAM 27 to the FROM 26.

Note that a part or whole of the firmware program may be stored in the magnetic disks 101.

The host 2 instructs the magnetic disk device 1 to write data and read data by using access commands. These access commands include logical address information. The magnetic disk device 1 provides a logical address space to the host 2, and the host 2 designates a position in the logical address space by using the logical address information.

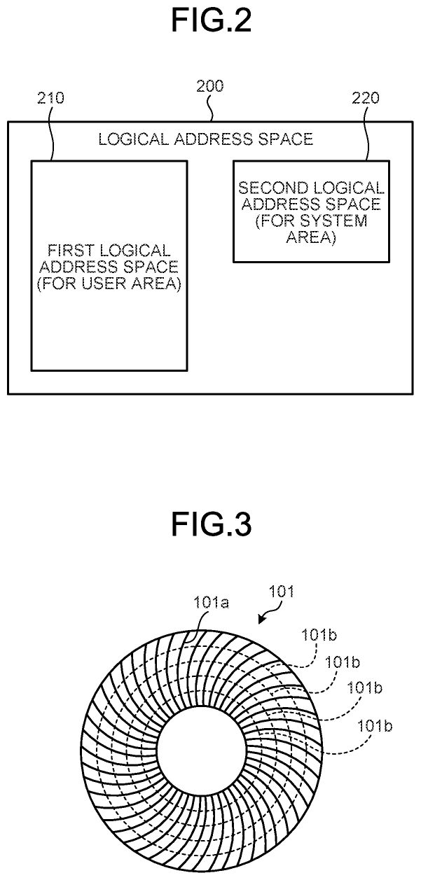

FIG. 2 is a schematic diagram for describing the logical address space included in the magnetic disk device 1 of the embodiment.

As illustrated in FIG. 2, the magnetic disk device 1 manages its own storage area by a logical address space 200. The logical address space 200 includes a first logical address space 210 mapped to the user area, and a second logical address space 220 mapped to the system area.

The user area is an area in which the data from the host 2, that is, user data is stored. The system area is an area in which data used by the magnetic disk device 1 for its own control, that is, system data is stored. The system data includes, for example, a log.

The magnetic disk device 1 provides the first logical address space 210 to the host 2. In a case of receiving an access command from the host 2, the controller 20 interprets that the logical address information included in the access command indicates a position in the first logical address space 210, and processes the access command.

In addition, in a case where it is necessary to access the system area, the controller 20 specifies logical address information indicating a position in the second logical address space 220. Then, the controller 20 interprets that the specified logical address information indicates the position in the second logical address space 220, and accesses the position associated with the specified logical address information.

Note that a numerical range of the logical address information of the first logical address space 210 and a numerical range of the logical address information of the second logical address space 220 may overlap or may not overlap. However, when interpreting logical address information, the controller 20 can specify whether the logical address information indicates a position in the first logical address space 210 or a position in the second logical address space 220.

For example, the controller 20 interprets that the logical address information included in the access command indicates the position in the first logical address space 210. In addition, the controller 20 interprets that the logical address information specified for writing/reading of the system data indicates the position in the second logical address space 220.

The logical address information is, for example, a logical block address (LBA). Hereinafter, the description will be made on the assumption that the logical address information is the LBA.

FIG. 3 is a view illustrating an example of a configuration of each of the magnetic disks 101 of the embodiment.

Magnetic layers are respectively provided on both surfaces of each of the magnetic disks 101, and the recording surfaces are configured by the magnetic layers. Servo information is written on each of the recording surfaces by a servo writer, self-servo writing, or the like before shipment. The servo information is, for example, a burst pattern. Servo zones 101a arranged radially are illustrated in FIG. 3 as an example of an arrangement of servo zones in which the servo information is written. In a radial direction of each of the magnetic disks 101, a plurality of concentric tracks 101b is provided at a predetermined pitch. Many sectors in which data is recorded are continuously formed on a circumference of each of the tracks 101b.

A physical position of each of the sectors is specified by, for example, address information of a cylinder/head/sector (CHS) system. Address information indicating a physical position of each of the sectors, that is, physical address information is hereinafter referred to as CHS.

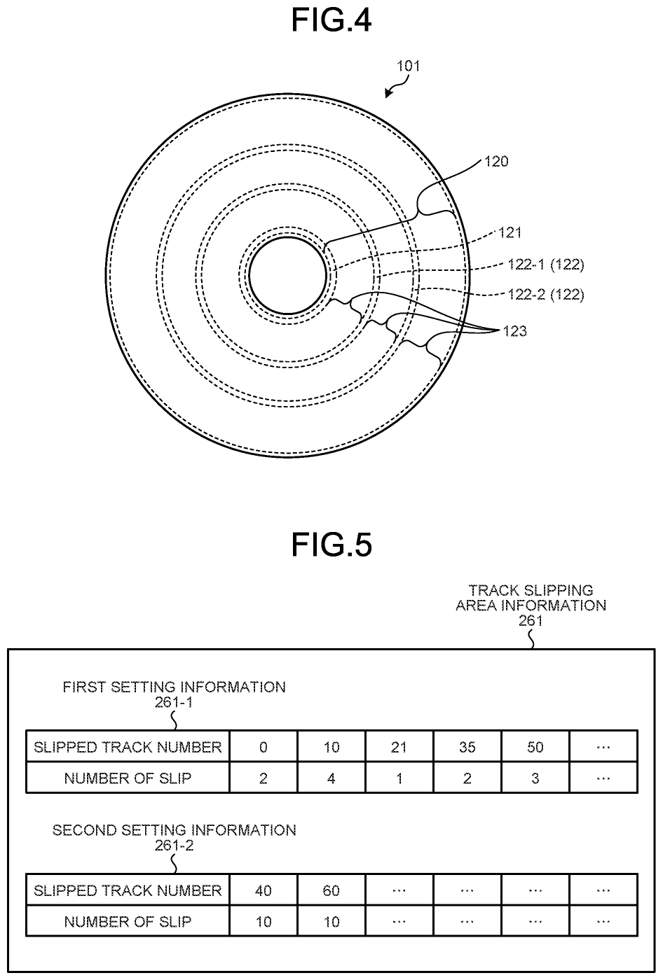

The controller 20 sets a plurality of kinds of areas on each of the recording surfaces, and uses the various kinds of areas differently. FIG. 4 is a view for describing the various kinds of areas set on each of the recording surfaces of the magnetic disks 101 of the embodiment.

One or more tracks 101b on the innermost circumferential side in an area 120 provided with the plurality of tracks 101b are set as a spare area 121. In a case where a sector that becomes difficult to be used is generated due to generation of a new defect or the like during operation, that is, while an end user uses the magnetic disk device 1, a sector in the spare area 121 is used instead of the sector that becomes difficult to be used. It becoming difficult to use a sector means that reading data written in the sector is difficult. Such processing of using the sector in the spare area 121 instead of the sector that becomes difficult to be used is referred to as a reassigning operation. In addition, each of the sectors in the spare area 121 is referred to as a spare sector.

The reassignment information 262 illustrated in FIG. 1 is, for example, a list of pairs of CHS indicating a sector that becomes difficult to be used and CHS indicating a spare sector to be used instead of the sector that becomes difficult to be used. The controller 20 acquires CHS indicating a sector of an access destination. In a case where a pair related to the CHS is recorded in the reassignment information 262, the access destination is changed to a spare sector indicated by the CHS associated by the reassignment information 262. Note that the reassignment information 262 is an example of third setting information of the embodiment.

A minimum unit of the reassigning operation may not be a sector. For example, the reassigning operation may be performed in units of a plurality of sectors. Hereinafter, the description will be made on the assumption that the reassigning operation is executed in units of a sector.

A position of the spare area 121 is not necessarily limited to the innermost peripheral side of each of the recording surfaces. One or more tracks 101b at an arbitrary position are fixedly set as the spare area 121.

The description returns to FIG. 4.

A plurality of system areas 122 separated in the radial direction is provided in the area 120. Each of the system areas 122 includes one or more tracks 101b. In the example illustrated in FIG. 4, two system areas 122-1 and 122-2 are provided in the area 120.

At the time of manufacturing of the magnetic disk device 1, a defect inspection is executed. A defect identified by the defect inspection at the time of manufacturing is referred to as a primary defect. On the basis of a result of the defect inspection at the time of the manufacturing, some of the tracks 101b may be set unusable. A determination criterion of unusability is arbitrary. In one example, a track 101b including at least one sector that is difficult to be read is set unusable, and a track 101b not including the sector that is difficult to read is not set unusable. Each of the system areas 122 includes one or more tracks 101b selected from the tracks 101b excluding the track 101b set unusable. That is, each of the system areas 122 includes one or more tracks 101b that passes the defect inspection at the time of the manufacturing.

A position at which each of the system areas 122 is set in the radial direction may be common to all the recording surfaces or may vary among the recording surfaces. Since each of the system areas 122 is set according to the result of the defect inspection at the time of the manufacturing, the position at which each of the system areas 122 is set in the radial direction may vary among the recording surfaces.

Note that as described above, in a case where a sector that becomes difficult to be used is generated due to generation of a new defect or the like in the system areas 122 during the operation, a spare sector is used instead of the sector that becomes difficult to be used. Such a defect generated during the operation is referred to as a secondary defect, a subsequent defect, or the like.

An area denoted by a reference sign 123 in the area 120 except for the spare area 121 and the system areas 122 is a user area 123. In a case where a sector that becomes difficult to be used is generated due to generation of the secondary defect or the like in the user area 123, a spare sector is used instead of the sector that becomes difficult to be used as in the case of the system areas 122.

Note that the two system areas 122 separated in the radial direction are provided in the example illustrated in FIG. 4. One system area 122 may be provided on one recording surface.

The first logical address space 210 is mapped to the user area 123, and the second logical address space 220 is mapped to the system areas 122. The mapping is managed by utilization of the track slipping area information 261.

A track number is given to each of the tracks 101b set on each of the recording surfaces. Then, groups of LBAs are linearly associated with sector groups arrayed in order of the track numbers. However, on the basis of the track slipping area information 261, some of the tracks 101b may be slipped at the time of association. Slipping means exclusion from a target of association of the LBAs. That is, when the groups of LBAs are associated with the sector groups arrayed in the order of the track numbers, the association is performed while sector groups included in some of the tracks 101b are skipped. The track slipping area information 261 is information for specifying the tracks 101b excluded from the target of association of the LBAs.

FIG. 5 is a view illustrating an example of a data structure of the track slipping area information 261 of the embodiment.

As illustrated in FIG. 5, according to the embodiment, the track slipping area information 261 includes first setting information 261-1 and second setting information 261-2.

The first setting information 261-1 is information indicating a track 101b set to be disused by the defect inspection at the time of manufacturing. According to FIG. 5, as an example, the first setting information 261-1 has a data structure in which a slipped track number and the number of slips are recorded. In a case where one or more tracks 101b having consecutive track numbers are unusable, the smallest track number among the track numbers of the one or more tracks 101b is recorded as the slipped track number, and the number of tracks 101b included in the one or more tracks 101b is recorded as the number of slips.

The second setting information 261-2 is information indicating all the tracks 101b included in each of the system areas 122. The second setting information 261-2 has, for example, a data structure similar to that of the first setting information 261-1. That is, in a case where one or more tracks 101b having consecutive track numbers are set in each of the system areas 122, the smallest track number among the track numbers of the one or more tracks 101b is recorded as the slipped track number, and the number of tracks 101b included in the one or more tracks 101b is recorded as the number of slips.

Thus, according to the example illustrated in FIG. 4, the smallest track number among the track numbers of the one or more tracks 101b included in the system area 122-1 is recorded as the slipped track number, and the number of tracks 101b included in the system area 122-1 is recorded as the number of slips. Furthermore, the smallest track number among the track numbers of the one or more tracks 101b included in the system area 122-2 is recorded as the slipped track number, and the number of tracks 101b included in the system area 122-2 is recorded as the number of slips.

As described above, the track slipping area information 261 of the embodiment includes the track 101b set unusable according to the result of the defect inspection at the time of the manufacturing, and the tracks 101b set as the system areas 122. That is, the track slipping area information 261 of the embodiment can be considered to indicate the tracks 101b having two kinds of attributes. One of the two kinds of attributes is the track 101b set unusable on the basis of the result of the defect inspection at the time of the manufacturing, and the other of the two kinds of attributes is the tracks 101b set as the system areas 122.

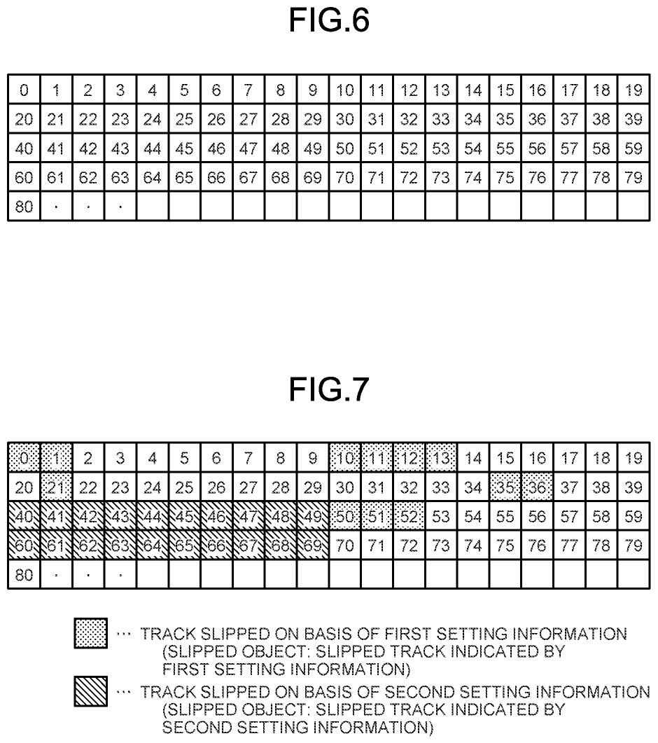

A usage of the track slipping area information 261 will be described with reference to FIG. 6 to FIG. 8. Note that the description using FIG. 6 to FIG. 8 follows an example of the track slipping area information 261 illustrated in FIG. 5.

FIG. 6 is a view illustrating an example of a track format of the magnetic disk device 1 of the embodiment. In the present drawing, the track numbers of the many tracks 101b included in the magnetic disk device 1 are drawn in order from a track number “0”. Note that it is assumed that a group of track numbers illustrated in the present drawing does not include a track number of the track 101b set as the spare area 121. Hereinafter, there is a case where a track 101b the track number of which is “X” is referred to as a track #X.

In a case where the access destination is the user area 123, the controller 20 converts an LBA indicating the access destination into CHS while slipping the tracks 101b indicated by the first setting information 261-1 and the tracks 101b indicated by the second setting information 261-2.

According to the example illustrated in FIG. 5, the first setting information 261-1 indicates a track #0, a track #1, a track #10 to a track #13, a track #21, a track #35, a track #36, and a track #50 to a track #52. The second setting information 261-2 indicates a track #40 to a track #49, and a track #60 to a track #69.

Thus, in a case where the access destination is the user area 123, as illustrated in FIG. 7, the dot-hatched track #0, track #1, track #10 to track #13, track #21, track #35, track #36, and track #50 to track #52 are slipped on the basis of the first setting information 261-1. Furthermore, the track #40 to the track #49 and the track #60 to the track #69 hatched with oblique lines are slipped on the basis of the second setting information 261-2.

The controller 20 linearly associates LBA groups of the first logical address space 210 with sector groups including unhatched tracks 101b, and then specifies CHS corresponding to the LBA indicating the access destination.

That is, the controller 20 associates, in order of values of the LBA, the LBA groups of the first logical address space 210 with sector groups that include the track #2 to track #9, the track #14 to track #20, the track #22 to track #34, the track #37 to track #39, the track #53 to track #59, and the track #70 to the track #80 and that are arrayed in the order of the track numbers. Then, on the basis of this correspondence, the controller 20 specifies the CHS corresponding to the LBA indicating the access destination.

Thus, the controller 20 realizes the access to an area avoiding the tracks 101b set unusable and the tracks 101b set as the system areas 122, that is, the user area 123.

In a case where the access destination is any of the system areas 122, the controller 20 converts the LBA indicating the access destination into CHS while slipping all the tracks 101b other than the tracks 101b indicated by the second setting information 261-2.

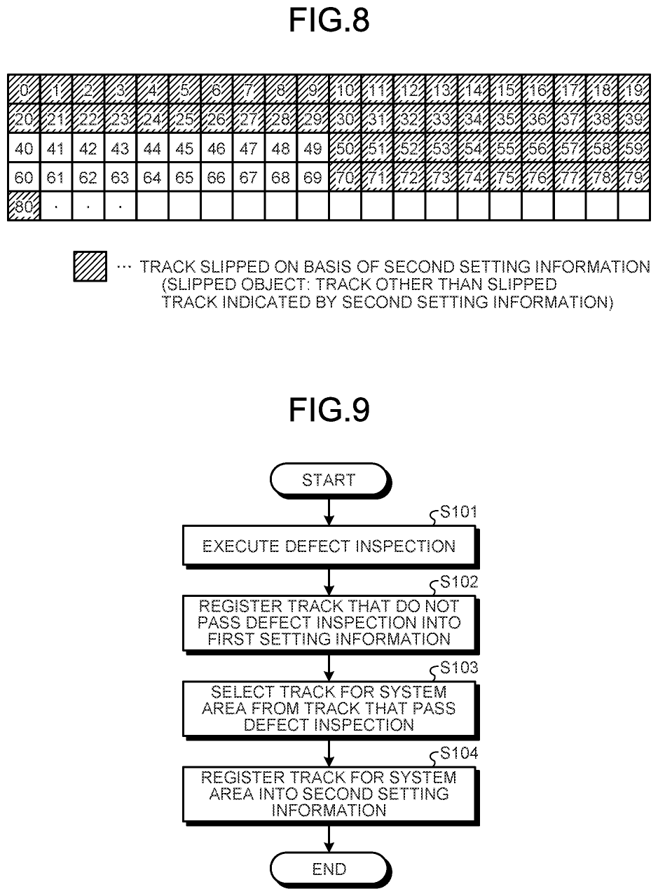

That is, as illustrated in FIG. 8, the track #0 to track #39, track #50 to track #59, and track #70 to track #80 hatched with the oblique lines are slipped on the basis of the second setting information 261-2.

That is, the controller 20 associates, in the order of values of the LBA, LBA groups of the second logical address space 220 with sector groups that include the track #40 to track #49, and the track #60 to track #69 and that are arrayed in the order of the track numbers. Then, on the basis of this correspondence, the controller 20 specifies the CHS corresponding to the LBA indicating the access destination.

Thus, access to the system area 122 is realized.

Next, an operation of the magnetic disk device 1 of the embodiment will be described. The magnetic disk device 1 performs setting of the track slipping area information 261 according to the firmware program at the time of the manufacturing.

FIG. 9 is a view illustrating an example of the operation of setting the track slipping area information 261 by the magnetic disk device 1 of the embodiment.

First, the controller 20 executes a defect inspection (S101). Then, the controller 20 registers, in the first setting information 261-1, a track 101b that does not pass the defect inspection (S102).

Subsequently, the controller 20 selects tracks 101b for the system areas 122 from the tracks 101b that pass the defect inspection (S103). Then, the controller 20 registers the tracks 101b for the system areas 122 in the second setting information 261-2 (S104). Then, the operation of setting the track slipping area information 261 ends.

Note that the system areas 122 are set by the operation illustrated in FIG. 9. The spare area 121 among the other areas may be arbitrarily set. For example, before the series of operations illustrated in FIG. 9, a predetermined number of tracks 101b at a specific position are fixedly set as the spare area 121. For example, in the example illustrated in FIG. 4, a predetermined number of tracks 101b on the innermost peripheral side may be set as the spare area 121, and the tracks 101b for the system areas 122 may be set while not only the track 101b that does not pass the defect inspection but also the spare area 121 are avoided.

Note that the registration of the tracks for the system areas 122 in the second setting information 261-2 may be executed on the basis of an instruction from a manufacturer. For example, the manufacturer gives an instruction on a desired position in the radial direction to the controller 20 from a computer terminal. The controller 20 may be configured to register one or more tracks 101b in the vicinity of the instructed position (except for the track 101b that does not pass the defect inspection) in the second setting information 261-2 in a case of receiving the instruction on the position in the radial direction from the manufacturer.

After shipment, the magnetic disk device 1 is connected to the host 2 by the end user, and operates in accordance with an access command from the host 2. In addition, the magnetic disk device 1 executes writing and reading of system data for its own control.

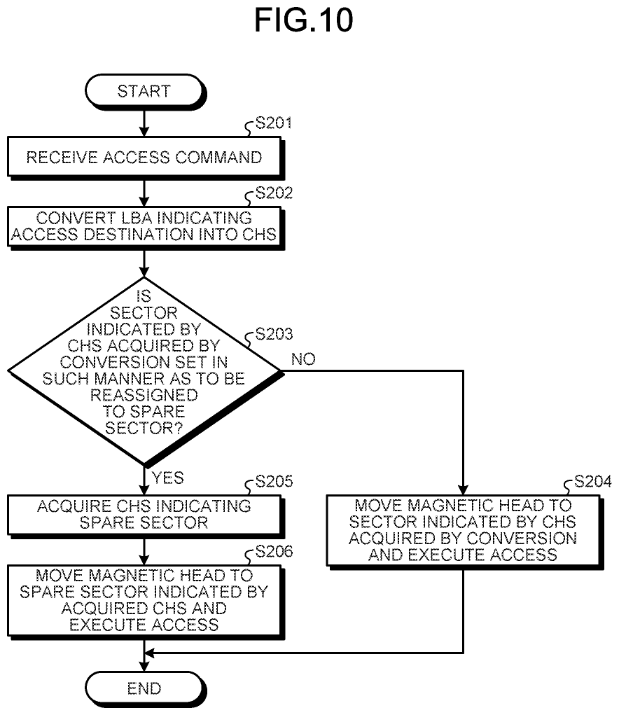

FIG. 10 is a flowchart illustrating an example of an operation, which corresponds to an access command from the host 2, of the magnetic disk device 1 of the embodiment.

When the controller 20 receives an access command from the host 2 (S201), the controller 20 converts an LBA indicating an access destination included in the access command into CHS (S202). Then, the controller 20 determines whether a sector indicated by the CHS acquired by the conversion is set to be reassigned to a spare sector (S203).

The CHS of the sector set to be reassigned by the spare sector is paired with CHS of the spare sector, and recorded in the reassignment information 262. In S203, with reference to the reassignment information 262, the controller 20 determines whether the sector indicated by the CHS acquired by the conversion is set to be reassigned to the spare sector.

In a case where the sector indicated by the CHS acquired by the conversion is not set to be reassigned to the spare sector (S203: No), the controller 20 moves the corresponding magnetic head 102 to the sector indicated by the CHS acquired by the conversion, and executes the access instructed by the access command (S204).

In a case where the access command received from the host 2 is a write command, the controller 20 writes data into the magnetic disks 101 in S204. In a case where the access command received from the host 2 is a read command, the controller 20 reads data from the magnetic disks 101 in S204.

In a case where the sector indicated by the CHS acquired by the conversion is set to be reassigned to the spare sector (S203: Yes), the controller 20 acquires CHS indicating the spare sector from the reassignment information 262 (S205). Then, the controller 20 moves the corresponding magnetic head 102 to the spare sector indicated by the acquired CHS, and executes the access instructed by the access command (S206).

After S204 or S206, the operation corresponding to the access command is ended.

Note that a case where an access range designated by the access command is one sector has been described in FIG. 10. In a case where the access range designated by the access command is a plurality of sectors, the controller 20 executes the processing of S202 to S206 on each of the plurality of sectors.

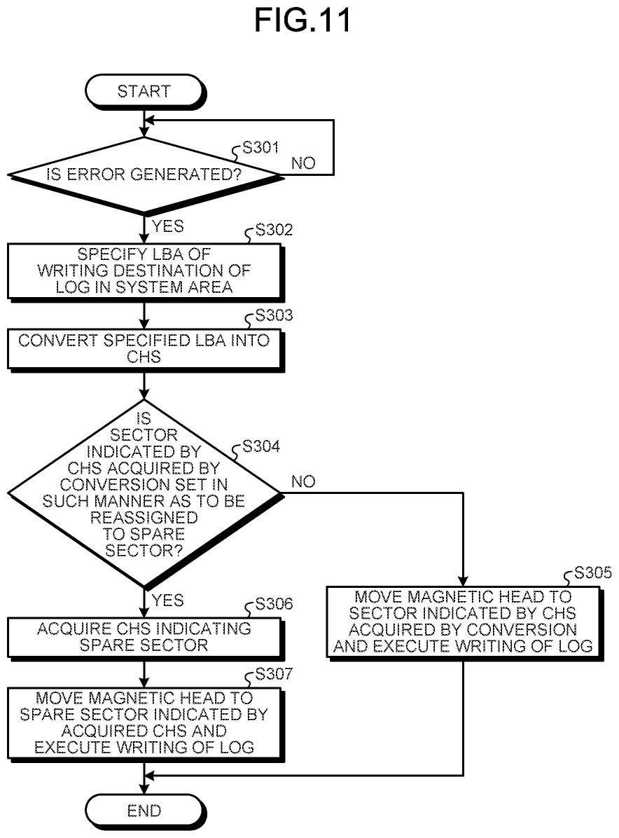

FIG. 11 is a flowchart illustrating an example of an operation of accessing the system areas 122 by the magnetic disk device 1 of the embodiment. Here, as an example, an operation of writing a log related to an error into each of the system areas 122 will be described.

The controller 20 monitors whether an error is generated (S301). For example, the controller 20 detects, as the error, a write error, a read error, excess of a predetermined level of vibration or impact strength, or the like.

In a case where the error is generated (S301: Yes), the controller 20 specifies an LBA of a writing destination of a log in the system area 122 (S302). A specification method of the LBA of the writing destination of the log is arbitrary. For example, in S302, the controller 20 specifies, as an LBA of a writing destination of a current log, an LBA at a position following a position where a log is written last time.

Then, the controller 20 converts the specified LBA into CHS (S303). Then, the controller 20 determines whether a sector indicated by the CHS acquired by the conversion is set to be reassigned to a spare sector (S304). The processing of S304 is executed by a method similar to that of the processing of S203, for example.

In a case where the sector indicated by the CHS acquired by the conversion is not set to be reassigned to the spare sector (S304: No), the controller 20 moves the corresponding magnetic head 102 to the sector indicated by the CHS acquired by the conversion, and writes the log related to the generated error (S305).

In a case where the sector indicated by the CHS acquired by the conversion is set to be reassigned to the spare sector (S304: Yes), the controller 20 acquires CHS indicating the spare sector from the reassignment information 262 (S306). Then, the controller 20 moves the corresponding magnetic head 102 to the spare sector indicated by the acquired CHS, and writes the log related to the generated error (S307).

After S305 or S307, the operation of writing the log into the system area 122 ends.

Note that a case where the log is written into one sector has been described in FIG. 11. In a case where logs of a plurality of sectors are written, the controller 20 executes the processing of S302 to S307 on each of the plurality of sectors.

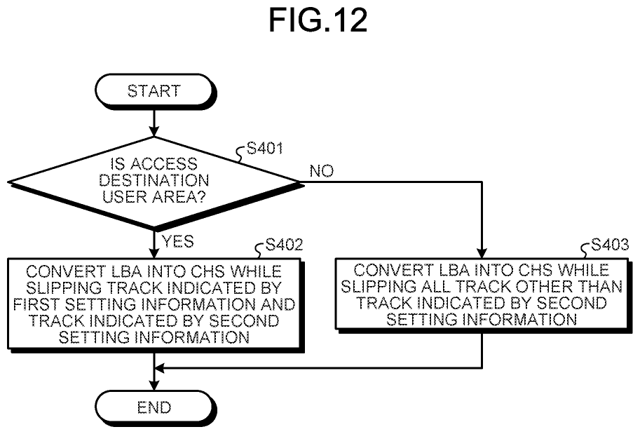

FIG. 12 is a flowchart illustrating an example of an operation of converting an LBA into CHS by the magnetic disk device 1 of the embodiment. The series of operations illustrated in FIG. 12 is executed in S202 illustrated in FIGS. 10 and S303 illustrated in FIG. 11.

The controller 20 determines whether the access destination is the user area 123 (S401).

In a case where the access destination is the user area 123 (S401: Yes), the controller 20 converts the LBA into the CHS while slipping the tracks 101b indicated by the first setting information 261-1 and the tracks 101b indicated by the second setting information 261-2 (S402). In S402, the controller 20 specifies CHS indicating the access destination by the method described with reference to FIG. 7.

In a case where the access destination is not the user area 123, (S401: No), that is, in a case where the access destination is any of the system areas 122, the controller 20 converts the LBA into the CHS while slipping all the tracks 101b other than the tracks 101b indicated by the second setting information 261-2 (S403). In S403, by the method described with reference to FIG. 8, the controller 20 specifies CHS indicating the access destination.

After S402 or S403, the operation of converting the LBA into the CHS ends.

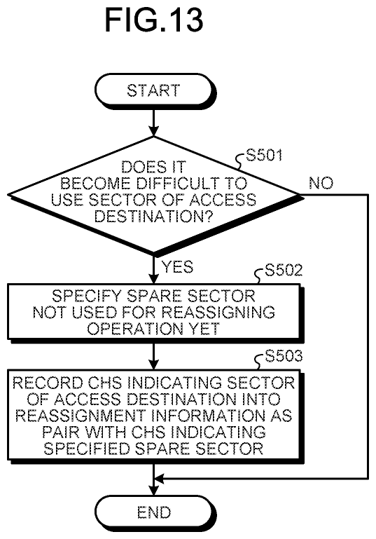

FIG. 13 is a flowchart illustrating an example of the reassigning operation executed by the magnetic disk device 1 of the embodiment. Note that the series of operations illustrated in FIG. 13 is executed regardless of whether the sector of the access destination is included in the user area 123 or the system area 122.

When accessing any of the sectors, the controller 20 determines whether it becomes difficult to use the sector of the access destination (S501).

A method of determining whether the sector of the access destination becomes difficult to be used is arbitrary. In one example, the RDC 22 has an error correction function. In a case where error correction by the error correction function fails continuously for a predetermined number of times or more at the time of reading of data from the sector, the controller 20 determines that the sector becomes difficult to be used. In the processing of S501, the sector in which the secondary defect is generated is specified as the sector that becomes difficult to be used.

In a case where it becomes difficult to use the sector of the access destination (S501: Yes), the controller 20 specifies a spare sector that is not used for the reassigning operation yet in the spare area 121 (S502). Then, the controller 20 records CHS indicating the sector of the access destination into the reassignment information 262 as a pair with CHS indicating the specified spare sector (S503). Then, the reassigning operation ends.

Note that when executing S503, the controller 20 may copy data in the sector of the access destination into the specified spare sector as necessary.

As described above, according to the embodiment, the first setting information 261-1 indicating a track 101b determined to be disused on the basis of the defect inspection, and the second setting information 261-2 indicating a track 101b for each of the system areas 122 which track is selected from the one or more tracks 101b different from the track 101b determined to be disused on the basis of the defect inspection are stored in the FROM 26. In a case where the access destination is the user area 123, the controller 20 converts an LBA indicating the access destination into CHS, which indicates a position on the magnetic disks 101, while slipping the track 101b indicated by the first setting information 261-1 and the track 101b indicated by the second setting information 261-2. In a case where the access destination is any of the system areas 122, on the basis of the second setting information 261-2, the LBA indicating the access destination is converted into the CHS, which indicates a position on the magnetic disks 101, while all the tracks 101b other than the track 101b indicated by the second setting information 261-2 are slipped. The controller 20 moves the corresponding magnetic head 102 to the position indicated by the CHS acquired by the conversion, and executes the access to the corresponding magnetic disk 101.

That is, arbitrary tracks 101b (except for the track 101b set to be disused on the basis of the defect inspection) can be set as the system areas 122 by the second setting information 261-2.

In one example, as illustrated in FIG. 4, it is possible to set a plurality of system areas 122 separated in the radial direction.

Here, a technique to be compared with the embodiment will be described. The technique to be compared with the embodiment is referred to as a comparative example. According to the comparative example, a predetermined number of tracks on an outer peripheral side of a magnetic disk are set as a system area. Thus, for example, in a case where it becomes necessary to access the system area when the magnetic head is located on an inner peripheral side, it is necessary to move the magnetic head from the inner peripheral side to the outer peripheral side. That is, a moving distance of the magnetic head to access the system area is long, and a lot of time is necessary to access the system area.

On the other hand, according to the embodiment, it is possible to set a plurality of system areas 122 separated in the radial direction, for example. By setting the plurality of system areas 122 separated in the radial direction, it is possible to reduce a moving distance of a magnetic head to access the system areas 122 and time necessary to access the system areas 122 as compared with the comparative example.

In addition, for example, according to the embodiment, when a manufacturer knows a position in the radial direction which position is frequently used by an end user, a track 101b near the position in the radial direction can be set as a system area 122.

Thus, even when it is necessary to access the system area 122, for example, to write a log related to an error or the like during execution of the access command, the moving distance of the magnetic head to access the system area 122 can be reduced, and the time necessary to access the system area 122 can be reduced.

As described above, according to the embodiment, it is possible to appropriately set the system area 122 in terms of controlling the time necessary to access the system area 122.

In addition, according to the comparative example, a system area includes tracks with a possibility of having a primary defect. That is, each of the tracks included in the system area may include a primary defect. Thus, one or more tracks having a capacity acquired by addition of an extra capacity in addition to the net capacity required as the system area are set as the system area.

On the other hand, according to the embodiment, each of the system areas 122 is set from the tracks 101b that pass the defect inspection at the time of manufacturing. Thus, the system area 122 may include only one or more tracks 101b having the required net capacity as the system area 122.

Thus, according to the embodiment, it is possible to use more tracks 101b as the user area 123 as compared with the comparative example.

As described above, according to the embodiment, it is possible to appropriately set the system area 122 in terms of controlling the number of tracks 101b secured as the system area 122.

In addition, according to the embodiment, in a case where an error is generated, the controller 20 executes access to write a log related to the error into the system areas 122.

Thus, the time necessary for the access to write the log related to the error is controlled.

Note that the access to write the log related to the error is an example of the access to the system areas 122. System data to be written into or read from the system areas 122 can be arbitrarily determined by the manufacturer.

Note that each of the magnetic disks 101 includes one or more tracks 101b set as the spare area 121 according to the embodiment. In a case where a sector that is difficult to be used is generated in any of the system areas 122 due to a secondary defect or the like, the controller 20 records CHS of the sector that is difficult to be used into the reassignment information 262 in association with CHS indicating a spare sector in the spare area 121. Then, in a case where CHS acquired by conversion of an LBA of the access destination is recorded in the reassignment information 262, the controller 20 moves the corresponding magnetic head 102 to the spare sector indicated by the CHS associated by the reassignment information 262, and accesses the corresponding magnetic disk 101.

Thus, even in a case where a sector that is difficult to be used is generated in any of the system areas 122 due to the secondary defect or the like, it is possible to keep the capacity of the area where the system data can be written.

According to the comparative example, system data may be multiplexed and written into the system area in preparation for generation of the secondary defect.

According to the embodiment, even when the secondary defect is generated in any of the system area 122, the spare sector is used instead of the sector that becomes difficult to be used due to the secondary defect. Thus, the system data does not need to be multiplexed and written into the system areas 122, and it is possible to control the capacity to be allocated to the system areas 122. In addition, since the system data is not multiplexed, time necessary to write the system data can be controlled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk having a plurality of first tracks;
a magnetic head;
a memory that stores first setting information indicating a second track that is a first track set to be disused on a basis of a defect inspection among the plurality of first tracks, and second setting information indicating a third track selected from one or more first tracks different from the second track among the plurality of first tracks; and
a controller
that converts, in a case where an access destination is a user area, first address information indicating the access destination in a logical address space into second address information indicating a position on the magnetic disk while slipping the second track and the third track on a basis of the first setting information and the second setting information, moves the magnetic head to the position indicated by the second address information, and accesses the magnetic disk, and
that converts, in a case where an access destination is a system area, third address information indicating the access destination in the logical address space into fourth address information indicating a position on the magnetic disk while slipping all of the first tracks other than the third track among the plurality of first tracks on a basis of the second setting information, moves the magnetic head to the position indicated by the fourth address information, and accesses the magnetic disk.

2. The magnetic disk device according to claim 1, wherein
in a case where an error is generated, the controller executes access to write a log related to the error into the system area.

3. The magnetic disk device according to claim 1, wherein
the controller
is configured to receive an access command from a host, and
determines, in a case where seventh address information indicating an access destination is address information designated by the access command, that the access destination is the user area.

4. The magnetic disk device according to claim 2, wherein
the controller
is configured to receive an access command from a host, and
determines, in a case where seventh address information indicating an access destination is address information designated by the access command, that the access destination is the user area.

5. The magnetic disk device according to claim 1, wherein
the plurality of first tracks includes a fourth track different from the third track,
the memory further stores third setting information, and
the controller
records, in a case where a first area that is difficult to be used is generated in the third track, fifth address information indicating the first area in the third track into the third setting information in association with sixth address information indicating a second area in the fourth track, and
moves the magnetic head to the second area indicated by the sixth address information and accesses the magnetic disk in a case where the fourth address information corresponds to the fifth address information.

6. The magnetic disk device according to claim 2, wherein
the plurality of first tracks includes a fourth track different from the third track,
the memory further stores third setting information, and
the controller
records, in a case where a first area that is difficult to be used is generated in the third track, fifth address information indicating the first area in the third track into the third setting information in association with sixth address information indicating a second area in the fourth track, and
moves the magnetic head to the second area indicated by the sixth address information and accesses the magnetic disk in a case where the fourth address information corresponds to the fifth address information.

7. The magnetic disk device according to claim 3, wherein
the plurality of first tracks includes a fourth track different from the third track,
the memory further stores third setting information, and
the controller
records, in a case where a first area that is difficult to be used is generated in the third track, fifth address information indicating the first area in the third track into the third setting information in association with sixth address information indicating a second area in the fourth track, and
moves the magnetic head to the second area indicated by the sixth address information and accesses the magnetic disk in a case where the fourth address information corresponds to the fifth address information.

8. The magnetic disk device according to claim 4, wherein
the plurality of first tracks includes a fourth track different from the third track,
the memory further stores third setting information, and
the controller
records, in a case where a first area that is difficult to be used is generated in the third track, fifth address information indicating the first area in the third track into the third setting information in association with sixth address information indicating a second area in the fourth track, and
moves the magnetic head to the second area indicated by the sixth address information and accesses the magnetic disk in a case where the fourth address information corresponds to the fifth address information.

9. A magnetic disk device comprising:
a magnetic disk;
a magnetic head; and
a controller that controls access to the magnetic disk by using the magnetic head, wherein
the magnetic disk includes a user area, and a plurality of system areas separated in a radial direction.

10. The magnetic disk device according to claim 9, wherein
the plurality of system areas is set in an area that passes a defect inspection on a recording surface of the magnetic disk.

11. A method of controlling a magnetic disk device including a magnetic disk having a plurality of first tracks, the method comprising:
converting, in a case where an access destination is a user area, first address information indicating the access destination in a logical address space into second address information indicating a position on the magnetic disk while slipping a second track, which is a first track set to be disused on a basis of a defect inspection among the plurality of first tracks, and a third track, which is selected from one or more first tracks different from the second track among the plurality of first tracks, on a basis of first setting information indicating the second track and second setting information indicating the third track, moving a magnetic head to the position indicated by the second address information, and accessing the magnetic disk; and
converting, in a case where an access destination is a system area, third address information indicating the access destination in the logical address space into fourth address information indicating a position on the magnetic disk while slipping all of the first tracks other than the third track among the plurality of first tracks on a basis of the second setting information, moving the magnetic head to the position indicated by the fourth address information, and accessing the magnetic disk.

12. The method according to claim 11, further comprising
executing, in a case where an error is generated, access to write a log related to the error into the system area.

13. The method according to claim 11, further comprising
receiving an access command from a host, and
determining, in a case where seventh address information indicating an access destination is address information designated by the access command, that the access destination is the user area.

14. The method according to claim 12, further comprising
receiving an access command from a host, and
determining, in a case where seventh address information indicating an access destination is address information designated by the access command, that the access destination is the user area.

15. The method according to claim 11, wherein
the plurality of first tracks includes a fourth track different from the third track,
the method further comprising
recording, in a case where a first area that is difficult to be used is generated in the third track, fifth address information indicating the first area in the third track into third setting information in association with sixth address information indicating a second area in the fourth track, and
moving the magnetic head to the second area indicated by the sixth address information and accessing the magnetic disk in a case where the fourth address information corresponds to the fifth address information.

16. The method according to claim 12, wherein
the plurality of first tracks includes a fourth track different from the third track,
the method further comprising
recording, in a case where a first area that is difficult to be used is generated in the third track, fifth address information indicating the first area in the third track into third setting information in association with sixth address information indicating a second area in the fourth track, and
moving the magnetic head to the second area indicated by the sixth address information and accessing the magnetic disk in a case where the fourth address information corresponds to the fifth address information.

17. The method according to claim 13, wherein
the plurality of first tracks includes a fourth track different from the third track,
the method further comprising
recording, in a case where a first area that is difficult to be used is generated in the third track, fifth address information indicating the first area in the third track into third setting information in association with sixth address information indicating a second area in the fourth track, and
moving the magnetic head to the second area indicated by the sixth address information and accessing the magnetic disk in a case where the fourth address information corresponds to the fifth address information.

18. The method according to claim 14, wherein
the plurality of first tracks includes a fourth track different from the third track,
the method further comprising
recording, in a case where a first area that is difficult to be used is generated in the third track, fifth address information indicating the first area in the third track into third setting information in association with sixth address information indicating a second area in the fourth track, and
moving the magnetic head to the second area indicated by the sixth address information and accessing the magnetic disk in a case where the fourth address information corresponds to the fifth address information.
